(19) United States
(12) Patent Application Publication
(10) Pub. No.: US 2005/0195064 A1
(43) Pub. Date: Sep. 8, 2005

(54) shape memory bistable actuator

(75) Inventors: Marco Biasiotto, Torino (IT); Francesco Butera, Torino (IT); Stefano Alacqua, Rivoli Cascine Viea (IT)

Correspondence Address: SUGHRUE MION, PLLC, 2100 PENNSYLVANIA AVENUE, N.W., SUITE 800, WASHINGTON, DC, 20037, US

(73) Assignee: C.R.F. SOCIETA CONSORTILE PER AZIONI

(21) Appl. No.: 11/052,300

(22) Filed: Feb. 8, 2005

(30) Foreign Application Priority Data
Mar. 3, 2004 (EP) 04425314.1

(51) Int. Cl. H01H 61/06

(52) U.S. Cl. 337/140

(57) ABSTRACT

A shape memory bistable actuator includes an element movable mounted on a fixed support structure, having an intermediate position of dead center and two end positions. Spring means tend to return the movable element towards either end positions, depending on that it is on either part with respect to the dead center position. Shape memory means are provided for causing a displacement of the movable element from either end positions, against the action of the spring means, at least until the dead center position is exceeded. After this exceeding, the activation of the shape memory means can be stopped, as the spring means provide to proceed the movable element toward the new desired working position, and to hold it in such a position, despite the shape memory means are deactivated.

### BACKGROUND OF THE INVENTION

The present invention generally relates to the shape memory actuators field.

Shape memory alloys have been developed and utilized since long in various fields. Such materials show the property of undergoing a transformation when their temperature varies above a transition value. By exploiting this property, shape memory actuators are used, for instance consisted of shape memory wires which, if warmed above the transition temperature, are subjected to a contraction. The heating is induced in some applications by passing through the wire an electric current, so as to warm it by the Joule effect.

The Applicant is the owner of various patents and patent applications relating to different applications of shape memory actuators.

### SUMMARY OF THE INVENTION

The present invention particularly relates to a shape memory actuator of a bistable type, i.e. of a type having two working positions between which it moves at every activation, the position every time reached being then stably held even after the actuator deactivation. In other words, in the actuators of this type, each following activation of the actuator causes its switching from a working condition to the other, and when the activation ends, the actuator remains in the position it has reached. Therefore, such actuators differ from monostable type actuators, wherein the actuator activation always causes the displacement of the actuator in one of the two working positions, whereas when the activation ends, the actuator always returns in the other working position.

The advantage of bistable actuators obviously resides in that, whatever the working condition in which the actuator is to be held, it is not necessary to consume energy (for example for supplying electric current through the shape memory wire) in order to hold it in such a position.

A shape memory actuator of a bistable type was already proposed by the Applicant in the European patent EP 1 241 351 B1.

The aim of the present invention is to carry out a shape memory bistable actuator which has an extremely simple structure and is cheap, and at the same time is reliable in its working.

In view of obtaining this aim, the object of the invention is a shape memory bistable actuator, characterized in that it comprises an element movable mounted on a support structure and having an intermediate position of dead center and two end positions, spring means tending to return the movably element towards either end positions, depending on that it is on either part of said dead center position, and shape memory means for causing a displacement of the movable element from either end positions, against the action of the above spring means, until the exceeding of the dead center position.

The elastic means preferably consist of spring means interposed between the movable element and the support structure. However, it is not excluded the case in which said elastic means have the same elasticity of the movable element, which in this case consists of an elastically deformable body.

In the preferred embodiment, the movable element is rotatably mounted around one axis on said support structure and the aforesaid spring means consist of a coil spring having one end connected to the support structure at a point spaced apart from the axis of rotation of the rotatable element and the other end connected to the rotatable element at a point also spaced apart from the axis of rotation of the rotatable element. With such a geometry, the dead center position of the rotatable element is the one in which the rotation center of the rotatable element and the fixing points of the spring ends are all aligned therebetween. When the fixing point of the spring on the movable element moves from said dead center, the spring tends to exalt this movement bringing the movable element in one of its two end positions. These end positions may correspond to the non-deformed condition of the spring, or may be defined by stop surfaces which determine a limit position of the rotatable element in both rotation directions.

Still in the case of the preferred embodiment, the above-mentioned shape memory means include at least a shape memory wire and means to supply electric current therethrough. Preferably, the shape memory wire has its two ends both connected to the fixed support structure and it is deviated around the pulley element. The shape memory wire is also connected to the rotatable element in correspondence with the same point in which the spring is fixed. Electric supply means are suitable for selectively supplying current through a first circuit including the spring itself and the tract of the shape memory wire which goes from a first end of this one until the fixing point of the spring on the rotatable element, or a second circuit, also including the spring and the second tract of the shape memory wire, which goes from the fixing point of the spring to the rotatable element until the other end of the wire.

Of course, it should be possible to provide a rotatable element simply consisted of a lever swinging around a rotation axis, and shape memory means consisted of two shape memory wires both connected to the lever element and which can be selectively activated for moving this lever in either directions around its swinging axis.

In the actuator according to the invention, the only purpose of the shape memory means is to bring the movable element to exceed its dead center position. Once this aim has been achieved, the displacement of the movable element till the new working position is determined by the spring, which also has the function of maintaining the new working position thus obtained after the deactivation of the shape memory means.

Therefore, the actuator according to the invention is characterized by an excellent simplicity and operation reliability and by a reduced energy consumption.

### BRIEF DESCRIPTION OF THE DRAWINGS

Further features and advantages of the invention will result from the following description with reference to the enclosed drawings, which are given by way of example but not limitation, wherein:

FIG. 1 is a diagrammatic view of a preferred embodiment of the actuator according to the invention, and

FIGS. 2, 3 show the actuator of FIG. 1 in two different working conditions.

### DETAILED DESCRIPTION OF THE INVENTION

In the drawings, numeral 1 generally shows a shape memory bistable actuator.

The actuator includes a fixed support structure 2 which is only shown diagrammatically in the drawings and may have any structure and shape. The actuator includes a movable element 3 in the form of a pulley rotatably mounted around an axis 4 on the fixed support structure 2. Around the pulley 3 a single shape memory wire 5 is returned, which has both its ends 5a, 5b secured to the fixed support structure 2 and is also rigidly secured to the pulley 3 in correspondence with a point 6. A coil spring 7 has one end 8 rigidly connected to the fixed support structure 2 at a point located on the vertical (in the drawing) passing through the axis of rotation 4, and the opposite end secured to the pulley 3, in correspondence with the same point 6 at which the shape memory wire 5 is secured.

Numeral 9 generally shows electrical supply means to the shape memory wire 5. These means include a first circuit 9a which includes a spring 7 and the part of the wire 5 which goes from the end 5a to the fixing point 6 of the pulley. The second circuit 9b still includes the spring 7 and the part of the wire 5 which goes from the fixing point 6 to the other end 5b of the wire. Numeral 10 diagrammatically shows an electric energy source and numeral 11 shows a switch which is able to activate the current passage through the first circuit 9a or through the second circuit 9b.

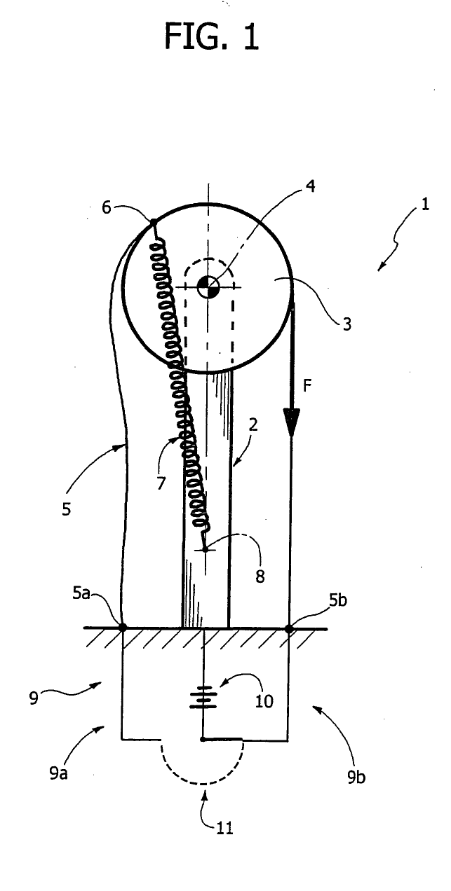

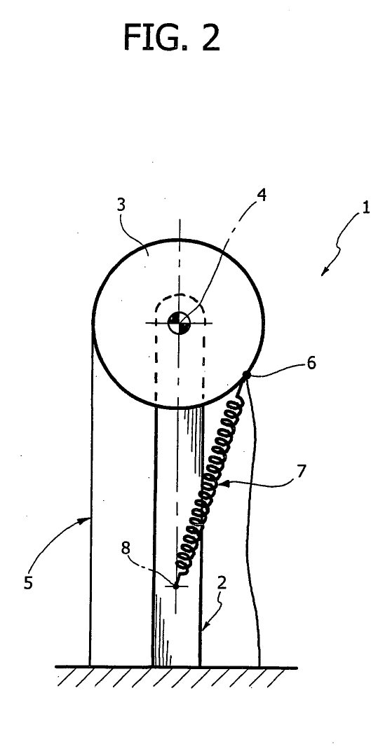

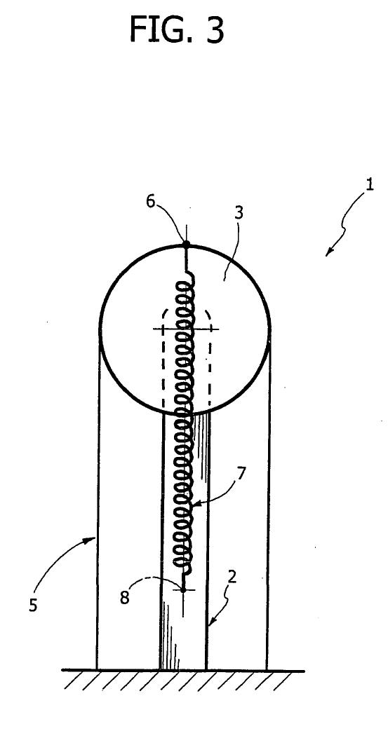

FIG. 1 shows the actuator according to the invention in an intermediate phase of its functioning, wherein the circuit 9b has been activated. In such a phase, the part of the shape memory wire 5 between the fixing point 6 and the end 5b is subjected to contraction, because of the heating determined by the current passage. In this phase, the part of the wire 5 between the end 5a and the point 6 is instead loosened. Therefore, within the above phase, the shape memory wire applies a force F to the pulley 3 which tends to rotate it clockwise (with reference to the drawing). The activation of the circuit 9b proceeds up to immediately after the dead center position has been reached, as shown in FIG. 3. In this position, the ends 6, 8 of the spring 7 and the axis of rotation 4 are aligned therebetween. Therefore, while in the phase shown in FIG. 1 the contraction of the tract 6-5b of the wire 5 determines the clockwise rotation of the pulley 3 against the action of the spring 7, with the exceeding of the condition of FIG. 3, the activation of the circuit 9b can be stopped, as it is the spring 7 itself which tends to forward the clockwise rotation of the pulley 3. This rotation then continues until a working position of the end of the pulley 3, which is shown in FIG. 2, is obtained. Such a position may correspond to a non-deformed condition of the spring 7 or to the engagement of a surface of the pulley 3 against a corresponding fixed end surface (not shown), which avoids a further shortening of the spring 7. Once the working position, shown in FIG. 2, has been obtained, this position is held without any energy consumption, until the user wishes to switch the actuator in the opposite working condition. In this case, the switch 11 will be driven so as to supply electric current through the circuit 9a. This will determine the shortening of the tract of the wire 5a-6 with consequent clockwise rotation of the pulley 3 against the spring 7 action. The activation of the circuit 9a is continued up to immediately after the dead center position, shown in FIG. 3, is obtained, after which the spring 7 itself will forward the counterclockwise rotation of the pulley 3 until a specularly symmetrical position is obtained, with respect to that of FIG. 2. Again, this position will be held due to the same spring 7, without the need of any energy consumption.

The possible applications of the actuator according to the invention are different. Indeed, such actuator may be used wherever the displacement of a movable element is required (in the shown case, an oscillating element around an axis of rotation), between two end working positions.

This is the case, for example, of an air baffle for automotive conditioning systems, oscillating between two end working positions.

Obviously, without prejudice for the principle of the invention, construction details and embodiments could widely vary with respect to what has been described and shown by mere way of example, however without leaving the scope of the present invention.

For example, the movable element 3 could be an elastically deformable element so as to oscillate between two end working positions, and the spring means, which tend to return the movable element towards either end positions, depending on the fact that it is on either part of the dead center position, could also have of the same elasticity of the deformable element.

1-9. (canceled)

10. Shape memory bistable actuator, including an element movably mounted on a support structure and having an intermediate position of dead center and two end positions, and spring means tending to return the movable element towards either end positions, depending on that it is on either part with respect to the dead center position, and shape memory means for causing a displacement of the movable element from either end positions, against the action of the above spring means at least until the exceeding of the dead center position,
wherein the elastic means consist of spring means interposed between said movable element and said fixed support structure,
wherein the movable element is rotatably mounted around an axis of rotation on the support structure, and the above spring means consist of a coil spring having one end connected to the support structure at a point spaced apart from the axis of rotation of the rotatable element, and the other end connected to the rotatable element at a point spaced apart from the axis of rotation,
wherein the shape memory means include at least a shape memory wire and means for supplying an electric current therethrough,
wherein the rotatable element is in the form of a pulley and the shape memory wire has both its ends connected to the fixed support structure and it deviated around the pulley element, said shape memory wire further being rigidly connected to the rotatable element,
wherein the feed means are suitable for selectively supplying electric current through a first circuit, including the spring and a first tract of the shape memory wire, and a second circuit-including the same spring and a second tract of the shape memory wire.

11. Bistable actuator according to claim 5, wherein said shape memory means include a plurality of shape memory wires arranged in parallel therebetween.
